(19) United States
(12) Patent Application Publication
(10) Pub. No.: US 2009/0307588 A1
(43) Pub. Date: Dec. 10, 2009

(54) Apparatus for controlling pointer operation

(75) Inventors: Makiko Tauchi, Kariya-city (JP); Asako Nagata, Chita-city (JP); Nozomi Kitagawa, Okazaki-city (JP); Takeshi Yamamoto, Anjo-city (JP); Takeshi Haruyama, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/457,010

(22) Filed: May 29, 2009

(30) Foreign Application Priority Data
Jun. 4, 2008 (JP) 2008-146560

(51) Int. Cl. G06F 3/048; G06F 3/01

(52) U.S. Cl. 715/702; 715/862

(57) ABSTRACT

An apparatus for controlling operation of an operation device controls the operation device in the following manner. That is, when a pointer on a display screen is controlled by the operation device, the operation of the operation device is regarded as an equivalent of a press operation of an OK button that affirms a certain decision, or as an equivalent of a press operation of a switch button that switches a current screen to the next one, upon detecting an exit of the pointer from a wall area of the screen.

### CROSS REFERENCE TO RELATED APPLICATION

The present application is based on and claims the benefit of priority of Japanese Patent Application No. 2008-146560, filed on Jun. 4, 2008, the disclosure of which is incorporated herein by reference.

### FIELD OF THE INVENTION

The present disclosure generally relates to an operation control system for controlling an operation of a pointing device or the like.

### BACKGROUND INFORMATION

Conventionally, a pointer operation unit such as a Joystick or the like operated by a user is controlled by applying a force from an apparatus side, for the purpose of improved usability, that is, for the smooth operation of a pointer in the screen. For example, Japanese patent document JP-A-2004-17761 discloses such a technique.

However, in the above technique, the user is required to perform an operation that is different from an operation for moving the pointer when he/she desires to initiate a process for activating a certain button after selection of the button, or to initiate a process for switching a current screen to the next screen.

### SUMMARY OF THE INVENTION

In view of the above and other problems, the present disclosure provides an operation control apparatus that is capable of initiating screen transition processing and button decision processing by way of a pointer movement operation.

In an aspect of the present disclosure, the operation control apparatus includes: an operation unit for receiving user operation including an operation for moving a pointer on a screen of a display unit, the user operation being received by a pointer operation unit in the operation unit; a display control unit for moving a display image of the pointer in the screen according to the operation of the pointer operation unit; an actuator for generating a reaction force that reacts to the operation of the pointer operation unit for moving the pointer in a first direction when the pointer is within a first range in a button image on the screen.

The operation unit for receiving the user operation in the operation control apparatus causes the actuator to provide the reaction force to the pointer operation unit when the pointer exists in the first range of the button image (e.g., within a periphery of the button image), moving in the first direction (e.g., the direction to move out from the periphery of the button image). That is, the operation of the pointer operation unit is resisted by the reaction force from the actuator when the pointer is controlled to move out from the button on the screen. Further, when the pointer comes out from the first range after moving in the first direction, the operation unit performs a process that is equivalent in effect to that a decision is made to press the button image by operating the operation unit.

The operation of the pointer operation unit by the user in the first direction is thus reacted by the reaction force, or a wall reaction force, in the first range. Further, when the pointer comes out from the first range as a result of the further operation in the first direction by the user against the wall reaction force, the wall reaction force disappears and a process that is equivalent to the result of the decision operation performed on the button image is performed.

According to the above operation scheme, the user achieves the same effect derived from performing the decision operation on the button image, together with the sensation of overcoming the reaction force. That is, only by performing an operation to cause the movement of the pointer, processing for handling the decision operation on a certain button can be started, accompanied by a kind of feedback that notifies and assures the user of an act of decision operation on the relevant button, through an arrangement of provision and removal (or disappearance) of the wall reaction force that suggests a turning point analogous to an act of getting-over a hilltop.

Further, when the pointer moves in the first range of the screen in the first direction, the reaction force is applied in the same manner as described above, with switching of a current screen to the next screen, or with an advanced notification of information regarding the next screen prior to the switching of the current screen based on a movement of the pointer in the first direction in the first range.

In this manner, the current screen is switched to the next one only by the pointer movement operation. Further, the user can get a confirmation of switching screens through discreteness of the two different haptic sensations in series, that is, the provision and removal of the reaction force.

Therefore, by providing the information on the next screen in advance, the user can have a clue leading a decision whether or not he/she should switch the current screen to the next one.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of construction of operation display apparatus according to an embodiment of the present disclosure;

FIG. 2 is a flow chart of a program executed by a device control unit;

FIG. 3 an illustration of a screen image showing buttons and other parts;

FIG. 4 is a diagram of reaction force potential in the X direction in FIG. 3;

FIG. 5 is a diagram of the reaction force potential in the Y direction in FIG. 3 and wall reaction force in the direction of Y of FIG. 3;

FIG. 6 is a flow chart of another program executed by the device control unit;

FIG. 7 is a flow chart of yet another program executed by a drawing unit;

FIG. 8 is an illustration of the screen image showing a next screen help; and

FIG. 9 is an illustration of the screen showing other type of contents.

### DETAILED DESCRIPTION

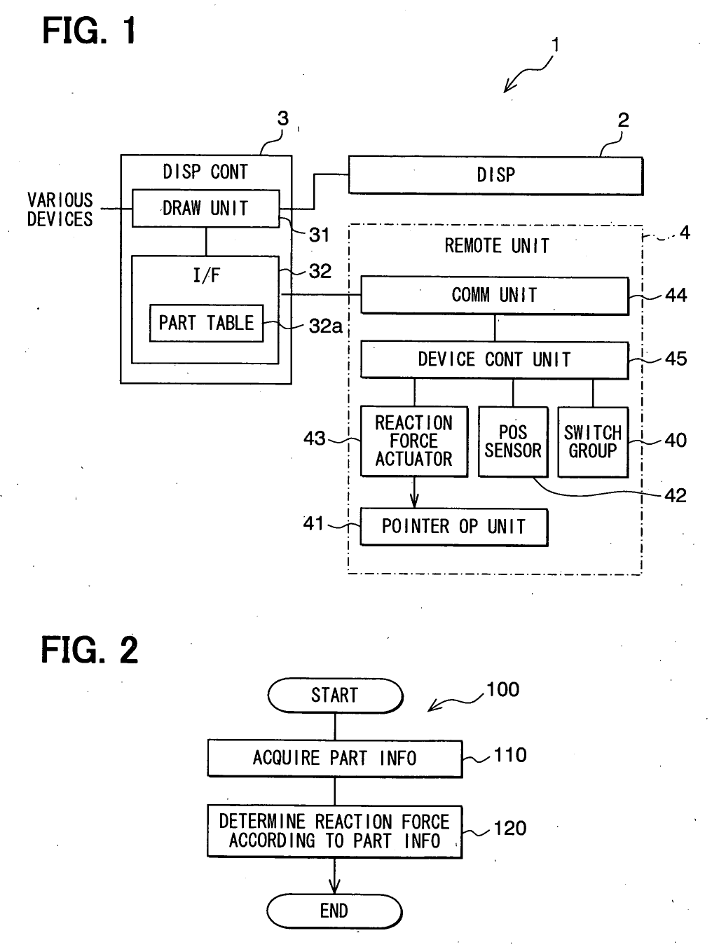

An embodiment of the present disclosure is described with reference to the drawings. FIG. 1 shows a composition of the operation control apparatus 1 according to this embodiment. An operation control system 1 is installed on a vehicle, and has a display unit 2 for showing an image for a driver of the vehicle, a display control unit 3 for controlling the image displayed on the display unit 2, and a remote unit 4 to receive user operation.

The display control unit 3 has a structure organized in the following manner. First, the display control unit 3 has a draw unit 31 and an interface unit 32.

The draw unit 31 exchanges signals with various sensors (e.g., a GPS receiver, a vehicle speed sensor) and actuators (e.g., a vehicle compartment air-conditioning device and an audio device, etc.) through vehicle LAN or the like, performs relevant processing based on the received signals, and controls the display unit 2 and actuators as required in the processing. Further, the draw unit 31 controls, in various processing, the display unit 2 on the basis of information on the user operation received from the remote unit 4 through the interface unit 32.

For instance, the draw unit 31 controls the display unit to display button images such as an OK button as well as selection buttons and the like for allowing the user to choose from them according to the operation of the remote unit 4 as a menu image in menu display processing, and, upon having an operation indicative of a user decision, performs the processing associated with the button operated by the user.

Further, the draw unit 31 calculates the guide route to the destination that the user has specified by operating the remote unit 4 on the basis of the map data (not shown in the drawing), and, for instance, guides the route along the calculated guide route in destination setting processing.

Further, the draw unit 31 controls the air conditioning system, for instance, in air-conditioning control processing according to the setting of the vehicle room temperature and the vehicle room air-flow amount that the user has specified by operating the remote unit 4.

Further, the draw unit 31 outputs, to the interface unit 32, a screen ID to identify a currently displayed screen on the display unit 2.

Further, the draw unit 31 superimposes a pointer in the screen on the display unit 2. The pointer is an image (for instance, a cross mark) to visually emphasize a specific position of the screen. The draw unit 31 changes the position of the pointer in the screen on the basis of information on the movement distance of the pointer received from the remote unit 4 through the interface unit 32.

The interface unit 32 is a device that mediates the communication of information between the draw unit 31 and the remote unit 4. More practically, the interface unit 32 outputs the signal received from the remote unit 4 to the draw unit 31.

Further, the interface unit 32 is capable of reading a part table 32a recorded in the storage medium not shown in the drawings. The part table 32a stores, for each of the screens that can be displayed on the display unit 2, the screen ID and information of parts of the screen.

The screen part information includes information on a screen part that is susceptible to the operation performed on the remote unit 4 by the user, that is, a button part hereinafter that can be selected and pressed for an input operation that is indicative of the user decision. More practically, the information of the button part defines an operation range of the button in the screen.

The operation of the button part indicative of the user decision indicates an operation that causes the function associated with the button part. On the other hand, the selection operation for selecting a button part is an operation to determine a certain button part to be handled as an object of a subsequent operation. For instance, the selection operation includes an operation to move the pointer into a display range of the button part.

In addition, the part information includes information of a wall part that causes a wall reaction force. That is, the wall reaction force is defined in the wall part of the screen. The area of the wall part in the screen may serve as an equivalent of a first range defined in claim language. Further, the wall part information includes a direction of the wall part, that is, an equivalent of a first direction in the claim language.

More practically, the direction of the wall part is a direction that is opposite to the direction of the wall reaction force in the range of the wall part. That is, when the pointer is operated by the user along the direction of the wall part, the reaction force that resists the user operation force is applied to a the pointer operation unit 41 toward an opposite direction of the wall part.

When the screen ID is acquired from the draw unit 31, the interface unit 32 extracts part information that is relevant to the currently displayed screen by referring to the part table 32a, and transmits the extracted information to the remote unit 4.

The draw unit 31 and the interface unit 32 may be implemented as two distinct software functions in one device such as a microcomputer, or may be implemented as two different pieces of hardware.

The structure of the remote unit 4 is organized in the following manner. The remote unit 4 has a switch group 40, a pointer operation unit 41, a position sensor 42, a reaction force actuator 43, a communication unit 44, and a the device control unit 45.

The switch group 40 includes the mechanical button that can be pressed down by the user. The mechanical button serves as a decision switch that receives the user operation indicative of the user decision.

The pointer operation unit 41 is an apparatus that receives the user operation that moves the above-mentioned pointer. More practically, the pointer moves on the basis of the contents of the user operation performed on the pointer operation unit 41.

More specifically, the pointer movement can be specified by a relative specification method that moves the pointer in the direction according to the operation direction of the pointer operation unit 41 at a speed corresponding to the amount of the operation of the pointer operation unit 41. Alternatively, the pointer movement can be specified by an absolute specification method that specifies a position of the pointer according to the operated position of the pointer operation unit 41.

The pointer operation unit 41 may be implemented as a stick shape device, for example, that is susceptible to a tilt operation in an arbitrary direction. In this case, the tilt angle represents the amount of the operation, and the azimuth angle represents the operation position.

Further, a mouse shape device may serve as the pointer operation unit 41. That is, the mouse shape may be moved on a certain plane to indicate an operation position, assuming that the operation amount is represented by the amount of the mouse movement and the operation position is represented by the coordinates of the current position on the certain plane.

The position sensor 42 is a device that outputs, to the device control unit 45, the detected operation position of the pointer operation unit 41. The operation position of the pointer operation unit 41 is, again, the tilt angle the azimuth angle of the stick shape device, or the operation amount and operation position of the mouse shape device.

The reaction force actuator 43 is a device that applies a force to the pointer operation unit 41 according to the control of the device control unit 45. When the force is applied to the pointer operation unit 41, the applied force is transmitted to the user's hand in the direction of the applied force applied to the pointer operation unit 41.

The communication unit 44 is a communication interface to perform information exchange with the interface unit 32 of the display control unit 3. The device control unit 45 can communicate with the display control unit 3 through the communication unit 44.

The device control unit 45 is a microcomputer that executes programmed processing. When the pointer operation unit 41 is operated, the device control unit 45 transmits, to the display control unit 3, a signal representative of the operation of the switch group 40 or the pointer operation unit 41, and determines the power and direction of the force applied by the actuator 43 to the pointer operation unit 41 according to the information from the display control unit 3 and the operation position of the pointer operation unit 41.

More practically, upon detecting that the button of the switch group 40 is pressed (e.g., a decision switch is pressed), the device control unit 45 transmits, to the display control unit 3, a signal that indicates that the decision button is pressed.

Further, the device control unit 45 transmits, to the display control unit 3, a current pointer position (two dimension data) and an amount of movement of the pointer position (two dimension data) on the basis of the operation position detected by the position sensor 42.

The operation of the operation control apparatus 1 organized in the above-mentioned manner is described. First, the movement of the pointer in the screen of the display unit 2 is described.

When the user operates the pointer operation unit 41, the operation position of the pointer operation unit 41 is detected by the position sensor 42, and the detected operation position is output to the device control unit 45. Then, the device control unit 45 calculates a new position and the amount of movement of the pointer in the screen on the basis of the detection result, and outputs information on the amount of movement to the display control unit 3. Information on the amount of movement is received through the interface unit 32 by the draw unit 31 in the display control unit 3, thereby moving the position of the pointer in the display unit 2 by the amount specified in the received information.

The pointer in the screen of the display unit 2 is changed in the above-described manner according to the operation contents of the pointer operation unit 41.

Further, when the user presses the decision switch, the device control unit 45 transmits the decision operation signal indicative of pressing of the decision switch to the draw unit 31, and, upon receiving the signal, the draw unit 31 executes the decision processing corresponding to the button in which the pointer is located at the time of signal reception.

Next, a method of setting the force applied to the pointer operation unit 41 by the device control unit 45 is described. The device control unit 45 executes a program 100 shown in FIG. 2 repeatedly for setting the force. First, the device control unit 45 in S110 waits for reception of the part information from the display control unit 3, and, after the acquisition of the part information upon switching of the screen in the display unit 2, proceeds to S120. The ‘S’ in an upper case is supplemented in front of step numbers as in the above description.

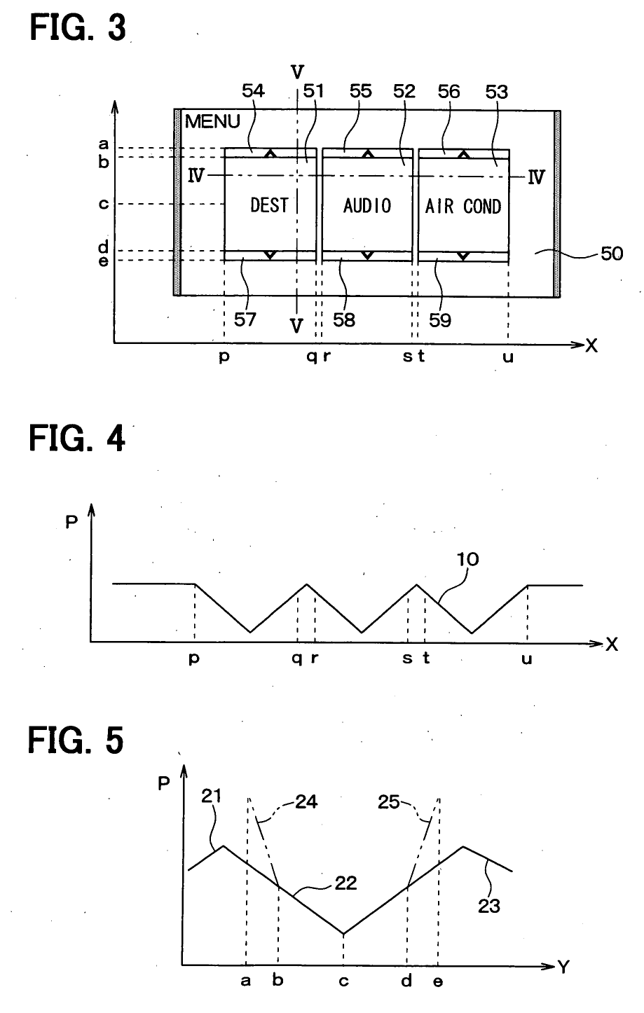

The arrangement of the button parts 51 to 53 and the arrangement of the wall parts 54 to 59 in a screen 50 are illustrated in FIG. 3. In the above example, three button parts 51 to 53 are arranged laterally from the left to the right in the screen 50, the upper ends of the button parts 51 to 53 respectively have the upward wall units 54 to 56 on their tops. Likewise, the lower ends of the button parts 51 to 53 respectively have downward wall parts 57 to 59 on their tops.

In S120, the reaction force is set according to the received part information, and the execution of the program 100 is finished for a current execution cycle. The reaction force is set in the following manner according to the received part information.

First, the reaction force that attracts the pointer into the range of the button part is set on the basis of the arrangement of the button parts. More practically, for each of the button parts, a potential P(X, Y) of the force that keeps increasing from a center of a button part toward its periphery is set. In this case, X and Y are the coordinate variables respectively in the direction from the left to the right and from the bottom to the top.

The vector of the reaction force applied to the pointer operation unit 41 at a certain operation position is calculated as an inverse of an incline of the potential P, that is, −P(X, Y). In other words, the direction of the reaction force at a certain operation position is a direction that maximizes the downward incline of the potential R The power of the reaction force becomes greater when the incline becomes steeper.

For instance, the potential P in the operation control apparatus 1 having the arrangement shown in FIG. 3 in the X direction can be represented as a graph 10 in a diagram as shown in FIG. 4. That is, the potential P along a line IV-IV in FIG. 3 is represented as a “cross section” by the graph 10 in FIG. 4. As shown in the graph 10, each of the button parts 51 to 53 has a valley shape potential that minimizes at the center of each button in the X direction with the increase towards the edges p, q, r, s, t, and u. In addition, the increase of the potential continues over the edges of each button as shown in FIG. 4. In other words, the potential P makes a mountain shape between two buttons.

Further, in the Y direction, that is, along a line V-V, the as shown by graphs 21 to 23 in FIG. 5, the potential P increases from the button center c towards the button edges a, e and further to make a mountain shape in the Y direction.

By having the above-described potential P shape, the reaction force applied to the pointer operation unit 41 causes the pointer to be attracted into the button area of one of the nearby buttons.

Further, as shown in FIG. 5, the pointer operation unit 41 has a potential of the wall reaction force, as an exception, being set for a certain range in the wall parts 54 to 59 (i.e., an example of a first range in the claim language) when the pointer moves along the direction of the wall parts (i.e., the pointer movement within an angle of 90 degrees relative to the direction of the wall parts). That is, as shown by a double-dotted line 24 in FIG. 5, the reaction force potential of the wall parts 57 to 59 in FIG. 3 is defined, and as shown by a double-dotted line 25 in FIG. 5, the reaction force potential of the wall 54 to 56 is defined.

The reaction force potential of the wall parts steadily increases in the wall parts direction (i.e., in the direction from b to a, and in the direction from d to e) from one edge of the wall part to the other edge as illustrated in FIG. 5. Further, the inclination angle of the potential of the reaction force of the wall parts is steeper than the inclination angle of the potential of the reaction force of the button parts. That is, the reaction force of the wall parts is stronger than the reaction force of the button parts.

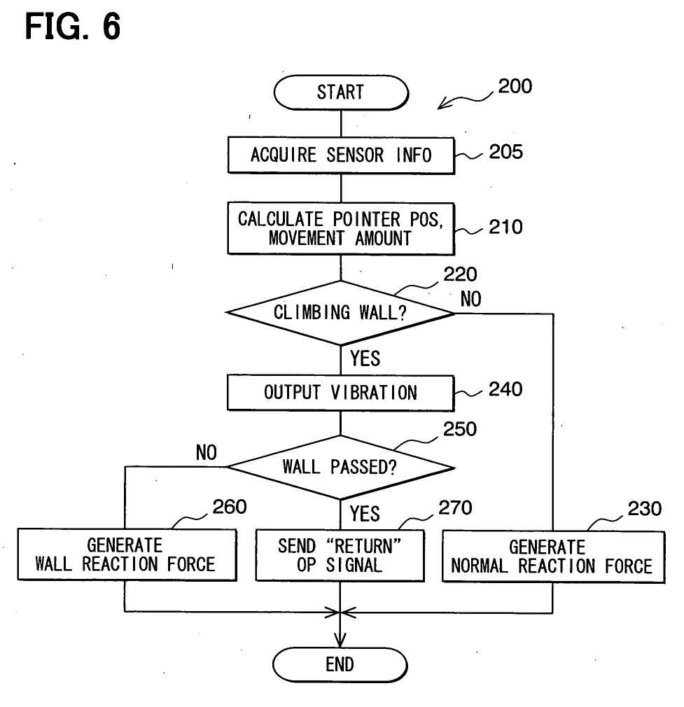

The processing of the control of the reaction force actuator 43 by the device control unit 45 is described in the following. The device control unit 45 repeatedly executes a program 200 shown in FIG. 6 for the control of the reaction force.

When the program 200 is executed, the device control unit 45 acquires information on the operation position and the amount of movement of the pointer operation unit 41 from the position sensor 42 in S205, and, in S210, on the basis of the acquired information, the device control unit 45 calculates a new position and the amount of movement of the pointer on the screen of the display unit 2 upon. In the same manner as mentioned in the description of the program 100, the letter ‘S’ is supplemented in front of each of the step number of the program 200, for the purpose of clarity.

Then, in S220, it is determined whether the pointer “climbs” the wall on the basis of calculated new pointer position and the amount of movement of the pointer. The pointer is determined as “climbing a wall” when the pointer is within the ranges of the wall parts, with the pointer movement in the direction of the wall parts. More specifically, when the pointer moves along the direction of the wall part, or in the direction ranging within 90 degrees relative to the direction of the wall part, the pointer is determined as climbing the wall. In other words, the potential of the reaction force of the wall parts increases, when the pointer climbs the wall. When the pointer is not climbing the wall, the process proceeds to S230. When the pointer is climbing the wall, the process proceeds to S240.

In S230, the reaction force of normal button parts at the current pointer position is calculated according to the setting result of the program 100. Then, the reaction force actuator 43 is controlled to apply the calculated reaction force to the pointer operation unit 41, and the execution of the program 200 is finished afterwards for the current execution cycle.

In S240, when the pointer is climbing the wall, the reaction force actuator 43 is controlled to apply a force to the pointer operation unit 41 for causing quick vibration of the pointer operation unit 41.

Then, in S250, it is determined whether the pointer has passed the wall, on the basis of the pointer position and the amount of pointer movement detected in S210. The pointer is determined as having passed the wall when the pointer comes out from the range of the wall parts as a result of the movement in the direction toward the boundary of the wall parts from within the wall parts. When the pointer is determined as being within the wall parts, the process proceeds to S260. When the pointer is determined as having passed the wall, the process proceeds to S270.

In S260, the wall reaction force of the wall part for the current pointer position is determined on the basis of a setting result of the program 100, and the reaction force actuator 43 is controlled to apply the wall reaction force determined above to the pointer operation unit 41. Then, the execution of the program 200 is finished for the current execution cycle.

Thus, during the operation period of the pointer operation unit 41, the device control unit 45 generates a normal reaction force (S230) when the pointer is not climbing the wall (S220:NO), or generates vibration (S240) and the wall reaction force stronger than the normal reaction force (S260) while the pointer is climbing the wall (S220:NO to S250:NO).

In S270, when the wall has been passed, the decision operation signal same as the signal transmitted to the display control unit 3 when the decision switch of the display 50 is pressed is transmitted to the display control unit 3. The draw unit 31 in the display control unit 3 starts the execution of the decision processing associated with the button with its boundary just being passed by the pointer, upon receiving the decision operation signal. In this case, depending on the time lag caused by the transmission of the signal from the remote unit 4 to the display control unit 3, the pointer may still be within the button range.

For instance, when the pointer climbs the wall part 54 to pass the wall part 54 while the screen having the arrangement as shown in FIG. 3 is displayed on the display unit 2, the execution of destination setting processing for setting a destination is started, and the screen for destination input is displayed as a next screen of the screen 50.

Thus, the remote unit 4 executes the same processing (for instance, display processing for displaying the next screen according to the button) as the processing performed at a time when the decision operation is performed on the button to which the wall part belong due to the fact that the pointer has climbed and passed the wall in the button range.

By devising the above operation scheme, when the user operates the pointer operation unit 41 to move the pointer into the wall parts and to move the pointer in the direction of climbing the wall, the reaction force is applied to the pointer operation unit 41. Further, when the user controls the pointer to climb and pass the wall against the reaction force, the wall reaction force disappears and processing equivalent to the decision operation being performed on the button whose boundary has just been passed is performed after the passing of the pointer over the boundary of the button.

Thus, the user achieves the same effect derived from performing the decision operation on the button and switching the screen to the next one, together with the sensation of overcoming the reaction force. That is, only by performing an operation to cause the movement of the pointer, processing for handling the decision operation on a certain button can be started for causing the switching of the current screen to the next one, accompanied by a kind of feedback that notifies and assures the user of an act of decision operation on the relevant button and an act of switching the screens, through an arrangement of provision and removal (or disappearance) of the wall reaction force that suggests a turning point analogous to an act of getting-over a hilltop.

Further, the attraction force generated by the reaction force actuator 43 associated with the buttons to attract the pointer in the button range is weaker than the wall reaction force. Therefore, the user can easily and unmistakably distinguish the wall reaction force from the attraction force, only by manually operating the pointer operation unit 41.

Further, it becomes impossible for the user to overcome the wall reaction force if the user does not have a clear and unmistakable intention for overcoming the wall reaction force, because the wall reaction force is stronger than the attraction force that attracts the pointer into the button range. Therefore, the possibility of an inadvertent decision operation caused by a mis-operation of the user is decreased.

Further, the actuator 43 vibrates the pointer operation unit 41 when the pointer is climbing the wall. In this manner, the user is intuitively notified through haptic sensation that, by continuing the current operation of moving the pointer, the decision operation or the screen switch operation will be performed.

Thus, by providing vibrations and/or sounds at an appropriate timing, notification for the user can be effectively and clearly provided, and transition from one screen to the other screen can be reminded for the user in the course of operation prior to the actual transition.

Further, the actuator 43 applies the “normal” reaction force for the pointer operation unit 41 instead of the wall reaction force when the movement of the pointer in the button range is opposite to the direction of the wall part. That is, by the movement opposite to the direction of the wall part, the pointer can move out of the button range with the weaker operation force relative to the wall reaction force.

By devising the above-described operation scheme, the wall reaction force is not applied to the pointer operation unit 41 unnecessarily during the operation for causing the pointer movement opposite to the direction of the wall part, which is not intended to switch screens and/or to perform the, decision operation.

Further, no other button parts exist in the screen 50 when the pointer moves out the button range by passing the wall parts 54 to 59 respectively on upper/lower edges of the button parts 51 to 53 as shown in FIG. 3. In addition, no wall part is arranged between two pieces of the button parts 51 to 53. Therefore, when the user moves the pointer from one button to the other button, there is no need for the pointer to take a detour to move around the wall part.

That is, in other words, the selection of the button part in the screen and the transition to the next screen can be smoothly performed.

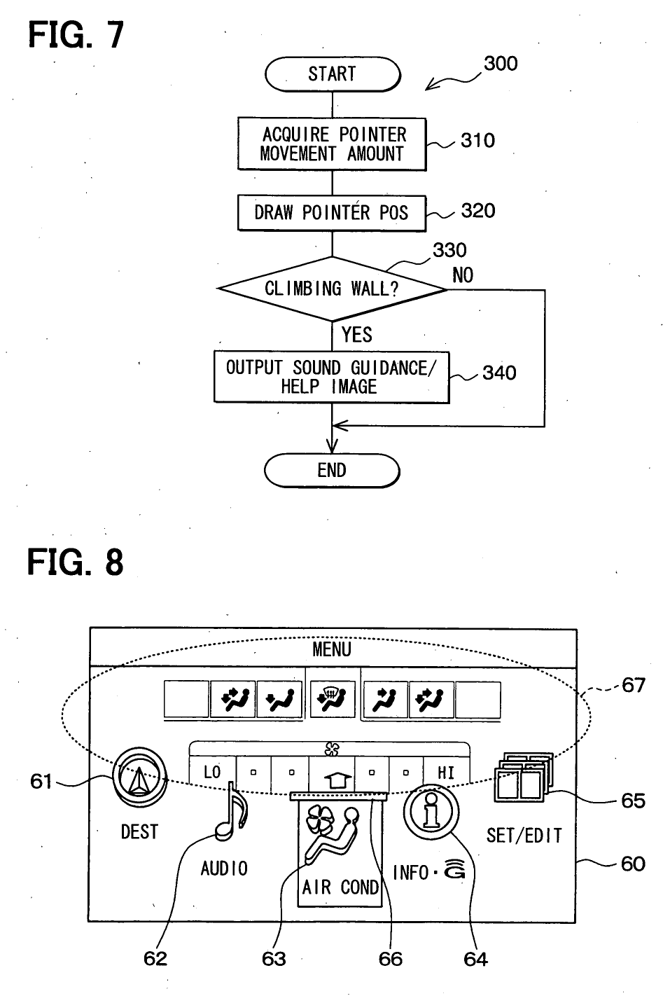

Next, processing for drawing the pointer by the draw unit 31 is described. The position of the pointer on the screen in the display unit 2 is changed by repeatedly executing a program 300 shown in FIG. 7 for the pointer drawing processing. That is, firstly receiving information on the amount of movement of the pointer from the remote unit 4 in S310 through the interface unit 32, and, continuously in S320, on the basis of the amount of pointer movement received, the position of the pointer is moved and drawn on the screen. The upper case ‘S’ is again supplemented in front of the step numbers in the specification.

Then, based on the latest position of the pointer and the received amount of pointer movement, it is determined whether the pointer is climbing the wall in S330. More practically, it is determined whether or not the pointer in the wall part is moving in the direction of the wall part. The direction of the wall part includes the range of direction within 90 degrees from the wall part direction.

If it is determined that the pointer is not climbing the wall, the execution of the program 300 is finished for the current execution cycle. If it is determined that the pointer is climbing the wall, the process proceeds to S340 for outputting the sound guidance (e.g., guidance voice or the like) and/or image guidance from an audio-visual device. Then, the execution of the program 300 is finished for the current cycle.

The contents of the sound guidance are, more specifically, an explanation of the next screen. For instance, while the draw unit 31 is displaying a menu screen on the display unit 2 and the pointer is climbing the wall of a wall part that is superimposed on an upper end of a bottom part of an air conditioner control button image in the menu screen, the sound guidance by voice that describes the next screen displayed by the decision processing associated with the air conditioner control button such as “In the next screen, temperature and wind circulation level of the air conditioner can be set.” is output. The sound guidance associated with the decision processing of each button may be pre-memorized in the storage medium in the display control unit 3 not shown in the drawings.

The contents of the sound guidance by voice may not necessarily be the explanation of the next screen. That is, for example, the sound guidance may announce that the continuation of the current pointer movement leads a start of the decision processing that is performed upon pressing the decision switch.

The contents of the image guidance may practically be a “help” for the next screen. For instance, while the draw unit 31 is displaying the menu screen on the display unit 2 and the pointer is climbing the wall of the wall part that is superimposed on the upper end of the bottom part of the air conditioner control button image in the menu screen, a group of button images illustrated as an item 67 in FIG. 8 may be superimposed on the current menu screen above of button images 61 to 65 in association with the air conditioner button 63.

In this case, from among the buttons 61 to 65, only the button 63 that is currently pointed by the pointer as shown in FIG. 8 may have the wall part 66 displayed thereon in the menu screen.

Thus, the remote unit 4 informs in advance the information on the next screen by using voice and/or image on the basis of the pointer climbing the wall. Because the information on the next screen is informed in advance when the pointer is climbing the wall, the user can take advantage of deciding whether the current screen should be switched to the next one.

Further, the remote unit 4 informs in advance the information on the next screen or the information on the pointer climbing the wall by voice. Therefore, only by operating the pointer operation unit 41 without watching the display unit 2, the user can understand that the current screen is going to be switched to which screen, or whether or not the pointer is currently climbing the wall.

### OTHER EMBODIMENTS

Although the present disclosure has been fully described in connection with preferred embodiment thereof with reference to the accompanying drawings, it is to be noted that various changes and modifications will become apparent to those skilled in the art.

For instance, in the above embodiment, the button parts are arranged in the lateral direction in the screen with the wall parts arranged on both of the upper and lower ends on the button parts as shown in FIG. 3.

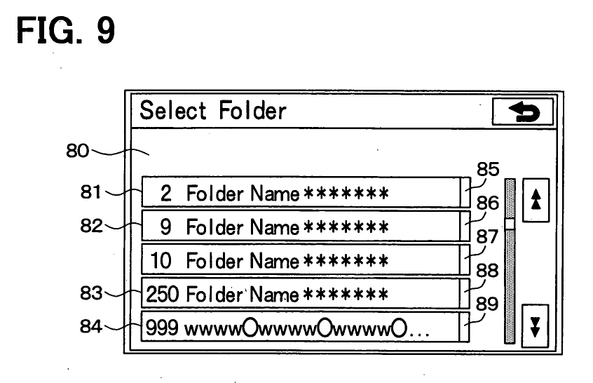

However, the arrangement of the button parts and wall parts may be formed in a different manner. That is, for example, the button part and wall part arrangement may be formed as a folder selection screen in a file system in the memory medium of the display control unit 3 as shown in FIG. 9.

In a menu screen 80, horizontally-extending button parts 81 to 84 for showing folder names are vertically arranged in a list form, and, on the right of each of the list entries of button parts 81 to 84, smaller button parts 85 to 89 are attached. Those smaller button parts 85 to 89 may, in this case, have the wall parts superposed on an entire area of each of the smaller button parts 85 to 89.

When the decision switch is pressed while the pointer is on one of the horizontally-extending buttons 81 to 84, the draw unit 31 switches the current screen to the folder contents screen that shows the file structure of the folder.

Further, when the decision switch is pressed when the pointer is in either of the smaller button parts 85 to 89, the draw unit 31 performs either of entire folder name display processing for displaying the folder contents or folder name read-out processing for announcing the folder names by voice.

The entire folder name display processing is processing for displaying the entire folder name when the entire folder name is longer than the display area size of the horizontally-extending button parts 81 to 84. That is, in other words, when the rear part of the folder name is not displayed in the horizontally-extending button parts 81 to 85, the rear part of folder name is displayed by the entire folder name display processing.

Further, smaller button parts 85 to 89 and the associated wall parts may be displayed on the right side of the buttons 81 to 84 only when the entire folder name does not fit in those buttons.

By devising the above display scheme and button arrangement, the device control unit 45 outputs the decision operation signal in S270 upon determining that the pointer has passed the wall in S250 (FIG. 6), when the pointer is moved rightward (i.e., an equivalent of a first direction in the claim language) in one of the smaller button parts 85 to 89 (i.e., an equivalent of a first range in the claim language). Then, the draw unit 31 performs the decision processing associated with one of the smaller button parts 85 to 89 upon receiving the decision operation signal. In other words, upon receiving the signal, the draw unit 31 performs either of the entire folder name display processing or the folder name read-out processing.

Further, as a modification of the above arrangement, the wall parts may be arranged in place of the smaller button parts 85 to 89 by abolishing the smaller button parts 85 to 89.

By adopting the above modification, the device control unit 45 and the draw unit 31 respond in the same manner as the above described operation procedure. That is, the device control unit 45 outputs the decision operation signal in S270 upon determining that the pointer has passed the wall in S250 (FIG. 6), when the pointer is moved rightward (i.e., an equivalent of a first direction in the claim language) in one of the smaller button parts 85 to 89 (i.e., an equivalent of a first range in the claim language). Then, the draw unit 31 performs the decision processing associated with one of the smaller button parts 85 to 89 upon receiving the decision operation signal. In other words, upon receiving the signal, the draw unit 31 performs either of the entire folder name display processing or the folder name read-out processing.

Further, the control unit 45 may identify the user who uses the operation control apparatus 1, and, for instance, may change the size of the wall reaction force according to the identified user.

The user of the apparatus 1 may be identified by, for example, an input of a user ID code by him/herself. Further, the relationship of the user with the wall reaction force may be defined in a table that is stored in the memory medium of the remote unit 4 (not shown in the drawing).

Further, the device control unit 45 may record, for each of the users, operation history. That is, for example, the number of times of passing a certain wall part by the user X may be recorded in the memory medium. In that case, the wall part may be recorded in association with the user if that wall part is climbed by the operation of that user for the number of times exceeding a threshold. The threshold of the wall passing times may be defined as the percentage (e.g., 5%) of the wall passing times of that wall part against the total wall passing times by the operation of that user.

Further, the device control unit 45 may shift the timing of the decision processing for a certain button earlier than the passing of the wall, based on the situation that the pointer is currently climbing the wall part that is associated with the current user according to the recorded relationship. The wall part and the user relationship may be alternatively recorded as the relationship between the next screen displayed after the decision operation on the wall part and the current user.

Thus, by shifting the decision operation timing to an earlier point, the usability of the operation control apparatus 1 can be improved. That is, when a user is frequently using a certain button for performing the decision operation, the decision operation associated with the wall part of the certain button may be time-shifted to an earlier timing for saving the user operation of passing the wall. In other words, the setting of the reaction force may be changed according to the user, the number of operation times or other factors, for the improvement of the operability of the operation control apparatus 1.

Further, the device control unit 45 may execute S250, for instance, by bypassing S240 when it is determined that the pointer is climbing the wall in S220. That is, the pointer operation unit 41 may not necessarily be vibrated when the pointer is climbing the wall.

Further, the normal reaction force and the wall reaction force used in the above embodiment may be replaced with the wall reaction force only. That is, other than the wall reaction force, the reaction force generated by the reaction force actuator 43 and applied to the pointer operation unit 41 may be set to zero.

Further, the wall parts may not necessarily be arranged in an attached manner with the button parts, as described in the above-mentioned embodiment. For instance, the device control unit 45 may put the wall parts along the periphery of the screen of the display unit 2, for causing the wall reaction force to be applied to the pointer entering the wall parts, in the direction toward the outside of the screen. In this manner, the pointer passing the wall to reach the screen edge switches the current screen to the next one. In this screen switching scheme, at least one of the three operations may be performed when the pointer enters the wall parts arranged on the periphery of the screen. That is, (1) the device control unit 45 vibrates the pointer operation unit 41, (2) the draw unit 31 provides the sound guidance of the next screen, and (3) the draw unit 31 displays image guidance (i.e., a help menu) of the next screen.

Further, even when the pointer moves in an opposite direction to the direction of the wall part in a certain wall part, the device control unit 45 may apply the wall reaction force to the pointer operation unit 41.

Further, the functions realized by the execution of the programs under control of the device control unit 45 and the draw unit 31 may alternatively be achieved by the programmable hardware such as FPGA or the like.

Such changes, modifications, and summarized scheme are to be understood as being within the scope of the present disclosure as defined by appended claims.

What is claimed is:

1. An operation control apparatus comprising:
an operation unit for receiving user operation including an operation for moving a pointer on a screen of a display unit, the user operation being received by a pointer operation unit in the operation unit;
a display control unit for moving a display image of the pointer in the screen according to the operation of the pointer operation unit;
an actuator for generating a reaction force that reacts to the operation of the pointer operation unit for moving the pointer in a first direction when the pointer is within a first range in a button image on the screen, wherein
the operation unit performs decision processing that is same as processing performed at a time when the button image receives a decision operation, if the pointer moves out of a boundary of the first range after a movement in the first direction in the first range.

2. The operation control apparatus of claim 1, wherein
the actuator generates an attractive force to attract the pointer towards the button image when the pointer is around the button image, and
the attractive force is made smaller than the reaction force.

3. The operation control apparatus of claim 1, wherein
the operation unit shifts a timing for performing the press operation on the button image earlier than a point of time when the pointer moves out of a boundary of the first range, based on a fact that the button image is associated with a user.

4. An operation control apparatus comprising:
an operation unit for receiving user operation including an operation for moving a pointer on a screen of a display unit, the user operation being received by a pointer operation unit in the operation unit;
a display control unit for moving a display image of the pointer in the screen according to the operation of the pointer operation unit;
an actuator for generating a reaction force that reacts to the operation of the pointer operation unit for moving the pointer in a first direction when the pointer is within a first range on the screen, wherein
the operation unit switches a screen of the display unit to a next screen when the pointer moves out of a boundary of the first range after a movement in the first direction in the first range, and
the operation unit notifies, in advance, information on the next screen based on a movement of the pointer in the first direction in the first range.

5. The operation control apparatus of claim 4, wherein
the information on the next screen is provided by voice.

6. The operation control apparatus of claim 4, wherein
the operation unit shifts a timing for switching the screen to the next screen earlier than a point of time when the pointer moves out of a boundary of the first range, based on a fact that the next screen is associated with a user.

7. The operation control apparatus of claim 1, wherein
the actuator vibrates the pointer operation unit, based on a fact that the pointer is moving in the first direction in the first range.

8. The operation control apparatus of claim 1, wherein
the actuator weakens the reaction force when the movement of the pointer is in an opposite direction relative to the first direction while the pointer is within the first range of the screen.
